(19) United States
(12) Patent Application Publication
(10) Pub. No.: US 2023/0008135 A1
(43) Pub. Date: Jan. 12, 2023

(54) METHOD OF MANAGING TACHOGRAPH DATA BASED ON BLOCKCHAIN NETWORK, AND APPARATUS AND SYSTEM FOR PERFORMING SAME

(71) Applicant: QUANTUM GATE INC., Seoul (KR)

(72) Inventors: Ju Yong BACK, Seoul (KR); Yongbae KIM, Goyang-si (KR); Jongweon KIM, Seoul (KR)

(73) Assignee: QUANTUM GATE INC., Seoul (KR)

(21) Appl. No.: 17/854,108

(22) Filed: Jun. 30, 2022

(30) Foreign Application Priority Data
Jul. 9, 2021 (KR) 10-2021-0090565

(51) Int. Cl. G06F 16/27; G07C 5/00

(52) U.S. Cl. CPC G06F 16/27; G07C 5/002

(57) ABSTRACT

Disclosed herein is a method of managing tachograph data based on a blockchain network. The method of managing tachograph data based on a blockchain network includes: allocating, by a tachograph, the block number of a block to be generated for tachograph data collected while a vehicle is driving; generating a block by using a server seed allocated by a server and a seed count value, which is a variable whose value changes each time the tachograph generates a block in an offline state; and transmitting the block hash value and block data of the generated block to the server.

### CROSS-REFERENCE TO RELATED APPLICATION

This application claims the benefit of Korean Patent Application No. 10-2021-0090565 filed on Jul. 9, 2021, which is hereby incorporated by reference herein in its entirety.

### BACKGROUND

### 1. Technical Field

The embodiments disclosed herein relate generally to technology for managing tachograph data based on a blockchain network, and more particularly to technology capable of improving reliability by preventing a user (a driver) from freely tampering with the tachograph data of a vehicle that is collected via a tachograph.

The embodiments disclosed herein were derived from the research conducted as part of the Land Transport Technology Promotion Research Project sponsored by the Korean Ministry of Land, Infrastructure and Transport and the Korea Agency for Infrastructure Technology Advancement (project management number: KAIA-152294).

### 2. Description of the Related Art

A tachograph is a device that records various types of information related to the driving state of a vehicle, e.g., a device that collects information about the speed, mileage, driving time, driver shift, and/or the like of a vehicle. The information collected in this manner is called tachograph data.

In order to improve traffic safety, it is necessary to store and manage tachograph data in a central management server so that violations such as excessive driving for a long time without break time, speeding, or reckless driving can be checked for frequently.

In particular, traffic safety can be improved by making the installation of a tachograph and the uploading of tachograph data compulsory for vehicles used in the transportation industry that requires relatively long operating times.

However, when tachograph data contains information unfavorable to a driver of a vehicle (e.g., the violation of the law such as a speed limit violation, or the like), there is a possibility that the driver may attempt to tamper with the tachograph data and upload the modified data to a server. If such tampering is not prevented, management and supervision based on tachograph data cannot be effectively performed.

The driver's attempt to tamper with tachograph data is highly likely to be made while a tachograph is not connected to a server over a network (in an offline state). Therefore, there is a need to develop technology that prevents a user (a driver) from freely tampering with even the tachograph data, collected when a tachograph is in an offline state, during an upload.

Meanwhile, the above-described background technology corresponds to technical information that has been possessed by the present inventor in order to contrive the present invention or that has been acquired in the process of contriving the present invention, and can not necessarily be regarded as well-known technology that had been known to the public prior to the filing of the present invention.

### SUMMARY

The embodiments disclosed herein intend to provide a method and system for preventing a user from freely tampering with the tachograph data collected when a tachograph is in an offline state in connection with the storage of the tachograph data collected via the tachograph in a blockchain network.

As a technical solution for accomplishing the above object, according to an embodiment, there is provided a method of managing tachograph data based on a blockchain network, the method including: allocating, by a tachograph, the block number of a block to be generated for tachograph data collected while a vehicle is driving; generating a block by using a server seed allocated by a server and a seed count value, which is a variable whose value changes each time the tachograph generates a block in an offline state; and transmitting the block hash value and block data of the generated block to the server.

According to another embodiment, there is provided a non-transitory computer-readable storage medium having stored thereon a program that, when executed by a processor, causes the processor to execute a method of managing tachograph data based on a blockchain network, the method including: allocating, by a tachograph, the block number of a block to be generated for tachograph data collected while a vehicle is driving; generating a block by using a server seed allocated by a server and a seed count value, which is a variable whose value changes each time the tachograph generates a block in an offline state; and transmitting the block hash value and block data of the generated block to the server.

According to still another embodiment, there is provided a computer program that is executed by a computing apparatus and stored in a non-transitory computer-readable storage medium in order to perform a method of managing tachograph data based on a blockchain network, the method including: allocating, by a tachograph, the block number of a block to be generated for tachograph data collected while a vehicle is driving; generating a block by using a server seed allocated by a server and a seed count value, which is a variable whose value changes each time the tachograph generates a block in an offline state; and transmitting the block hash value and block data of the generated block to the server.

According to still another embodiment, there is provided a tachograph for managing tachograph data based on a blockchain network, the tachograph including: a communication interface configured to communicate with a server; storage configured to store a program for managing tachograph data based on a blockchain network; and a controller including at least one processor, and configured to store the tachograph data in the blockchain network by executing the program; wherein the controller allocates the block number of a block to be generated for tachograph data collected while a vehicle is driving, generates a block by using a server seed allocated by the server and a seed count value, which is a variable whose value changes each time the tachograph generates a block in an offline state, and transmits the block hash value and block data of the generated block to the server.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a diagram showing a system for managing tachograph data based on a blockchain network according to an embodiment;

FIG. 2 is a diagram showing the structures of blocks generated for tachograph data according to an embodiment;

FIG. 3 is a diagram showing the detailed configurations of the devices included in the system shown in FIG. 1;

FIG. 4 is a diagram illustrating a process in which when a tachograph is in an online state, it generates a block for tachograph data and stores it in a blockchain network according to an embodiment;

FIG. 5 is a diagram illustrating a process in which when a tachograph is in an offline state, it generates a block for tachograph data and stores it in a blockchain network according to an embodiment;

FIG. 6 is a flowchart illustrating a method of managing tachograph data based on a blockchain network according to an embodiment; and

FIGS. 7 to 9 are diagrams illustrating a method of determining whether tachograph data has been tampered with in a method and system for managing tachograph data based on a blockchain network according to an embodiment.

### DETAILED DESCRIPTION

Various embodiments will be described in detail below with reference to the accompanying drawings. The following embodiments may be modified to various different forms and then practiced. In order to more clearly illustrate features of the embodiments, detailed descriptions of items that are well known to those having ordinary skill in the art to which the following embodiments pertain will be omitted. Furthermore, in the drawings, portions unrelated to descriptions of the embodiments will be omitted. Throughout the specification, like reference symbols will be assigned to like portions.

Throughout the specification, when one component is described as being “connected” to another component, this includes not only a case where the one component is “directly connected” to the other component but also a case where the one component is “connected to the other component with a third component arranged therebetween.” Furthermore, when one portion is described as “including” one component, this does not mean that the portion does not exclude another component but means that the portion may further include another component, unless explicitly described to the contrary.

Embodiments of the present invention will be described in detail below with reference to the accompanying drawings.

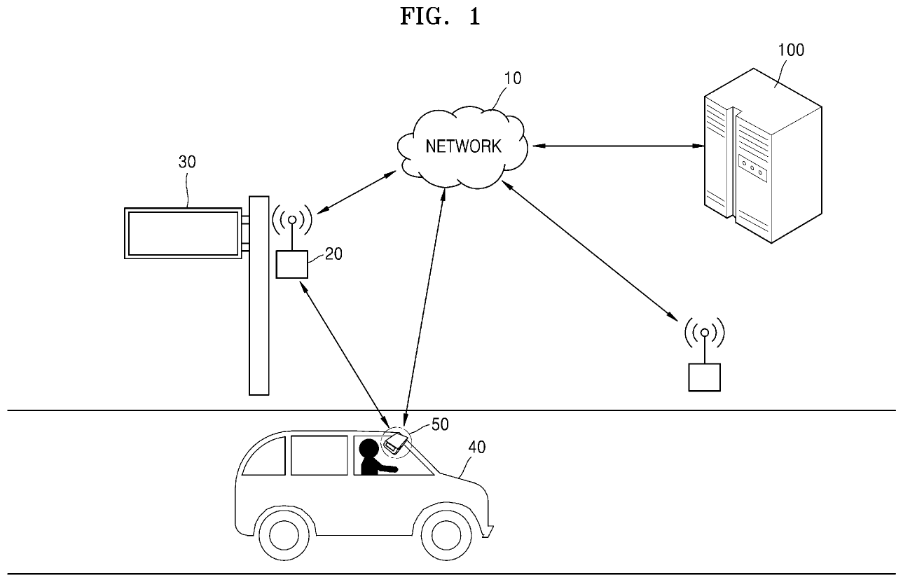

FIG. 1 is a diagram showing a system for managing tachograph data based on a blockchain network according to an embodiment. Referring to FIG. 1, the system according to the present embodiment may include a network 10, a roadside unit (RSU) 20, a traffic infrastructure 30, a vehicle 40, a tachograph 50, and a server 100. Furthermore, according to another embodiment, the system for managing tachograph data based on a blockchain network may further include various types of traffic infrastructures, although not shown in FIG. 1. Furthermore, according to another embodiment, the system may be configured to include two or more servers. Moreover, according to another embodiment, the system may include only the remaining components, excluding the RSU 20 and the traffic infrastructure 30.

The blockchain network may communicate with the server 100, and may be configured such that various electronic devices each having a storage function operate as nodes. For example, at least some of the server 100, the RSU 20, and the tachograph 50 may operate as nodes. Alternatively, although not shown in FIG. 1, other computing devices communicating with the server 100 may operate as nodes.

The network 10 is configured to enable wired/wireless communication among the RSU 20, the tachograph 50, and the server 100, which are devices constituting the blockchain network.

The RSU 20 may be installed on the roadside and communicate with the tachograph 50 installed in a nearby vehicle 40, and may operate as a node of the blockchain network in which tachograph data is stored. Such roadside units (RSUs) 20 may be independently installed on the roadside at regular intervals, or may be installed in traffic infrastructures 30 such as street lights, traffic lights, and/or road electric signs.

According to another embodiment, the system may be configured not to include the RSU 20 so that the tachograph 50 instead of the RSU 20 can operate as a node of the blockchain network, or other electronic devices capable of communicating with the server 100 may operate as nodes of the blockchain network.

The traffic infrastructure 30 refers to one of various infrastructures related to traffic, such as traffic lights, street lights, and road electric signs. As shown in FIG. 1, the RSU 20 may be installed in the traffic infrastructure 30, as shown in FIG. 1.

The tachograph 50 may be installed in the vehicle 40, and may record various types of information related to the driving state of the vehicle 40. For example, the tachograph 50 may collect information about the speed, mileage, driving time, driver shift, and/or the like of the vehicle 40 and store it as tachograph data.

The tachograph 50 may generate a block to store the collected tachograph data in the blockchain network, and may transmit data related to the generated block (e.g., a block, block data, and a block hash value) to the server 100. The server 100 serves to manage the blockchain network in which tachograph data is stored. A process in which the tachograph 50 generates a block including tachograph data and transmits related data to the server 100 to store it in the blockchain network will be described in detail below.

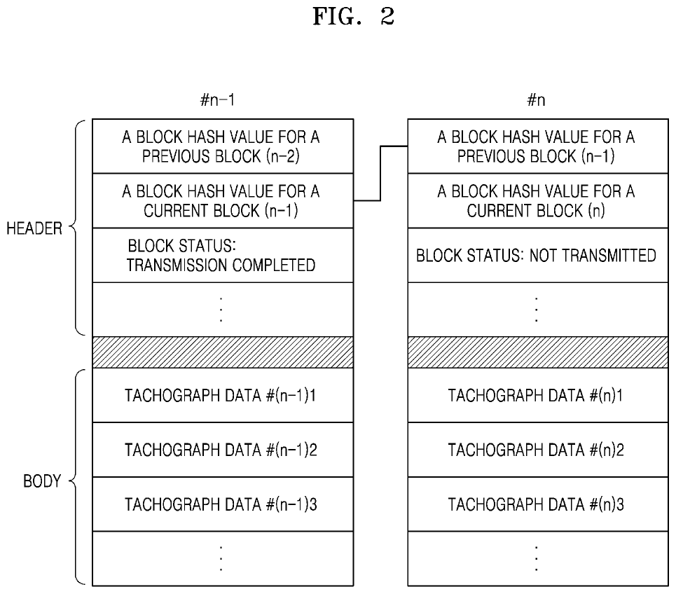

FIG. 2 is a diagram showing the structures of blocks generated for tachograph data according to an embodiment. Referring to FIG. 2, tachograph data is stored in the body of each of the blocks. The tachograph data may include various types of information related to the driving of the vehicle 40, and FIG. 2 shows a state in which information is divided and stored.

A block hash value for a previous block and a block hash value for a corresponding block are stored in the header of the block. In this case, the “block hash value” is the Merkle root of a Merkle tree composed of block-related hash values (e.g., a server key hash value, a previous block hash value, and a block data hash value). A method of obtaining a block hash value will be described in detail below. The block hash value for the corresponding block is stored as a “block hash value for a previous block” in the header of a subsequent block, so that the blocks are connected to each other.

According to an embodiment, “block status” may be stored in the header of a block. The block status is an item indicating whether data related to a corresponding block has been transmitted from the tachograph 50 to the server 100. The block status is set to “transmission completed” when the data related to the corresponding block is transmitted to the server 100, and is set to “not transmitted” when the data related to the block has not yet been transmitted to the server 100.

According to the embodiments described herein, data related to blocks generated when the tachograph 50 is in an offline state is not transmitted to the server 100 until the tachograph 50 enters into an online state, so that the block status of the blocks is set to “not transmitted.” When the tachograph 50 enters into an online state, it checks the block status of the headers of blocks, and transmits the data related to the blocks, set to “not transmitted,” to the server 100.

In addition, values such as version and nonce values may be stored in the header of a block. Since this is related with general blockchain technology, a detailed description thereof will be omitted.

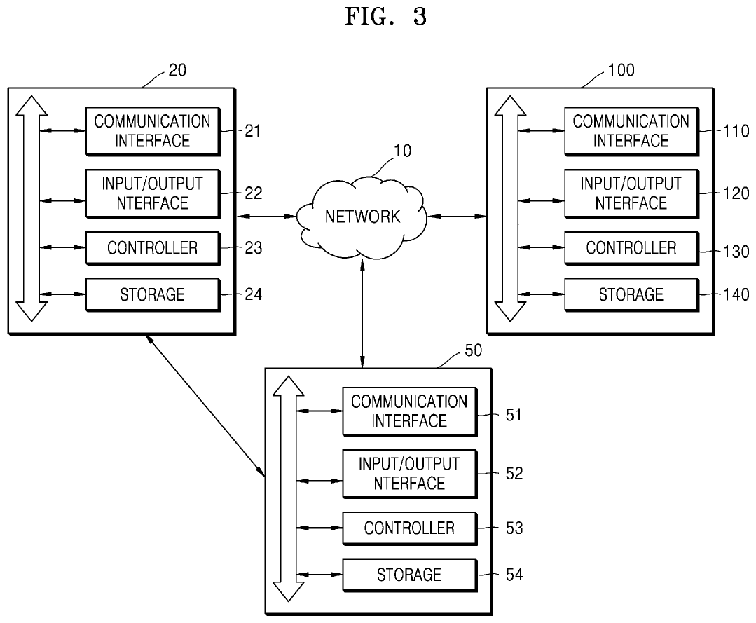

FIG. 3 is a diagram showing the detailed configurations of the devices included in the system shown in FIG. 1.

Referring to FIG. 3, the RSU 20, the tachograph 50, and the server 100 all include the same components. Accordingly, features common to individual components will be described once below. Each of the RSU 20, the tachograph 50, and the server 100 may further include another component in addition to the components shown in FIG. 3, and may not include some of the components shown in FIG. 3.

Communication interfaces 21, 51, and 110 are components that perform wired/wireless communication with other devices. To this end, each of the communication interfaces 21, 51, and 100 may include a chipset configured to support various types of wired/wireless communication protocols. The RSU 20, the tachograph 50, and the server 100 may transmit and receive data to and from each other through the communication interface 21, 51, or 100.

Input/output interfaces 22, 52, and 120 are components that receive data and commands and output results obtained by performing operational processing on the data in compliance with the commands. Each of the input/output interfaces 22, 52, and 120 may include input components such as a keyboard, hard buttons, and/or a touch screen, and an output component such as an LCD, and/or an OLED.

Controllers 23, 53, and 130 are components that each include at least one processor such as a central processing unit (CPU) and control the overall operation of a corresponding one of the devices 20, 50, and 100. Each of the controllers 23, 53, and 130 may perform the process of storing tachograph data collected by the tachograph 50 in the blockchain network by executing a program stored in corresponding storage 24, 54, or 140. The process by which the controller 23, 53, or 130 stores tachograph data in the blockchain network and determines whether tachograph data included in a block has been tampered with will be described in detail for each embodiment below. In the following description, the operations performed by the controllers 23, 53, and 130 of the respective devices 20, 50, and 100 may be described as being performed by the corresponding devices 20, 50, and 100 for convenience of description.

Pieces of storage 24, 54, and 140 are components that store files and programs, and may include various types of memory. In particular, data and programs adapted to enable the controller 23, 53, and 130 to perform operations according to embodiments to be described below may be stored in the storage 24, 54, and 140.

A method and system for managing tachograph data based on a blockchain network according to an embodiment uses a variable, called a “seed count,” to determine whether tachograph data included in a block has been tampered with. According to an embodiment, a seed count value is an encrypted file inside the tachograph 50, and may be opened only with a user's electronic wallet.

How a seed count value varies depending on whether the tachograph 50 generates a block in an online state or in an offline state, how a seed count value is used when a block is generated, and how the server 100 can determine whether tachograph data included in a block has been tampered with based on a seed count will be described in detail below with reference to the drawings.

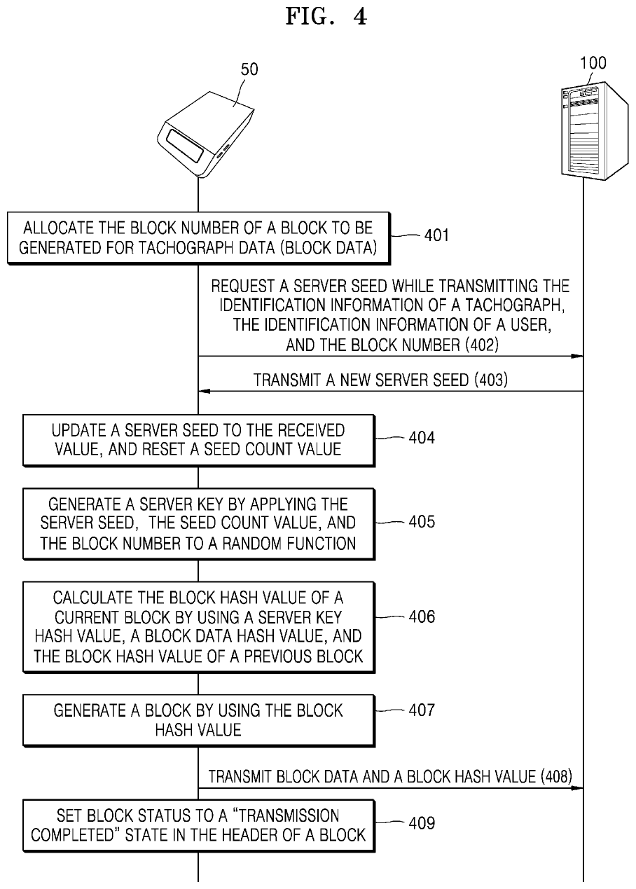

FIG. 4 is a diagram illustrating a process in which when the tachograph is in an online state, it generates a block for tachograph data and stores it in a blockchain network according to an embodiment.

Referring to FIG. 4, at step 401, the tachograph 50 allocates the block number of a block to be generated for the tachograph data collected while the vehicle 40 is driving. In this case, the tachograph data is included in the body of the generated block, so that it is also referred to as “block data.” A method by which the tachograph 50 allocates a block number may be implemented in various manners. According to an embodiment, the tachograph 50 may sequentially allocate block numbers while periodically generating blocks. For example, the tachograph 50 may increase the block number by 1 each time the date passes while generating one block per day. In this case, the block generated on a specific date stores the tachograph data collected on the corresponding date.

At step 402, the tachograph 50 requests a server seed from the server 100 while providing the identification information of the tachograph 50 (e.g., the serial number, model name, or the like of the terminal), the identification information of a user who has driven the vehicle 40 (e.g., a user ID or the like), and the block number to the server 100. The server seed is a value allocated by the server 100 to be used when the tachograph 50 generates a block, and may be a randomly generated 32-bit integer according to an embodiment. The server 100 may generate a server seed by using the identification information of the tachograph 50 received from the tachograph 50, the identification information of the user, and the block number (e.g., an output result obtained by applying the received information to a random function is used as the server seed). The server 100 may use the server seed when verifying the block hash value of a block generated by the tachograph 50.

When the server 100 transmits the server seed to the tachograph 50 at step 403, the tachograph 50 updates a server seed to the value received from the server 100 and resets a seed count value to 0 at step 404. In other words, when the tachograph 50 generates a block in an online state, the server seed is always updated to a new value, and the seed count value is reset to 0.

At step 405, the tachograph 50 generates a server key by applying the updated server seed, the seed count value, and the block number to a random function. In other words, the result that is output when the server seed, the seed count value, and the block number are applied as inputs to the random function becomes the server key.

At step 406, the tachograph 50 calculates the block hash value of a current block by using a server key hash value, a block data hash value, and the block hash value of a previous block. The server key hash value may be obtained by applying the server key generated at step 405 to the hash function, and the block data hash value may be obtained by applying the tachograph data (the block data) collected at step 401 to the hash function.

According to one embodiment, the tachograph 50 may construct a Merkle tree including the server key hash value, the block data hash value, and the block hash value of the previous block as leaf data, and may obtain the Merkle root of the corresponding Merkle tree as the block hash value of the current block.

At step 407, the tachograph 50 generates a block by using the block hash value obtained at step 406. In other words, the tachograph 50 generates a block including tachograph data (block data), and stores the block hash value in the header of the generated block.

The tachograph 50 transmits the block data and block hash value of the generated block to the server 100 at step 408, and sets block status to a “transmission completed” state in the header of the generated block at step 409. Once the block hash value has been transmitted to the server 100, all subsequent data changes may be checked by the server 100.

So far, the process in which when the tachograph 50 is in an online state, it generates a block for tachograph data and transmits data related to the block to the server 100 has been described. Next, a process in which when the tachograph 50 is in an offline state, it generates a block for tachograph data and transmits data related to the block to the server 100 will be described. However, redundant descriptions of steps similar to those described in FIG. 4 will be omitted.

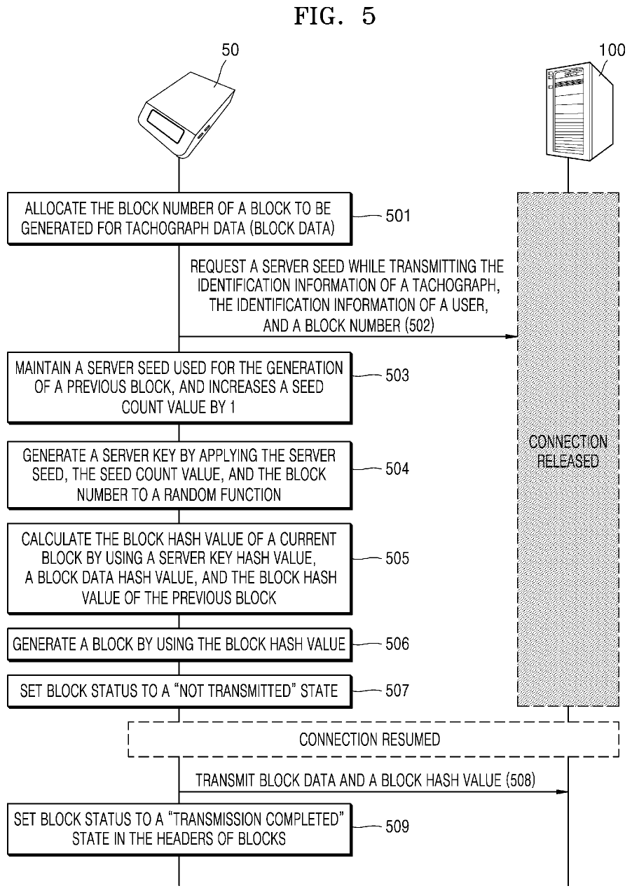

FIG. 5 is a diagram illustrating a process in which when the tachograph is in an offline state, it generates a block for tachograph data and stores it in a blockchain network according to an embodiment.

Referring to FIG. 5, at step 501, the tachograph 50 allocates the block number of a block to be generated for tachograph data. In this case, it is important to note that when a modification is made to specific tachograph data in the state where the connection between the tachograph 50 and the server 100 is continuously released after a block has been generated for the corresponding tachograph data, the tachograph 50 allocates a value identical to an existing block number as the block number of a block to be generated for the modified tachograph data.

Referring to a specific example, when a user freely accesses the tachograph 50 and then generates second tachograph data (i.e., a modified version of the first tachograph data) by modifying some of the first tachograph data in the state where the connection between the tachograph 50 and the server 100 is not resumed after block n has been generated for first tachograph data in the state where the connection between the tachograph 50 and the server 100 was released, the tachograph 50 deletes the previously generated block n, and generates a new block by using the same block number “n” for the second tachograph data.

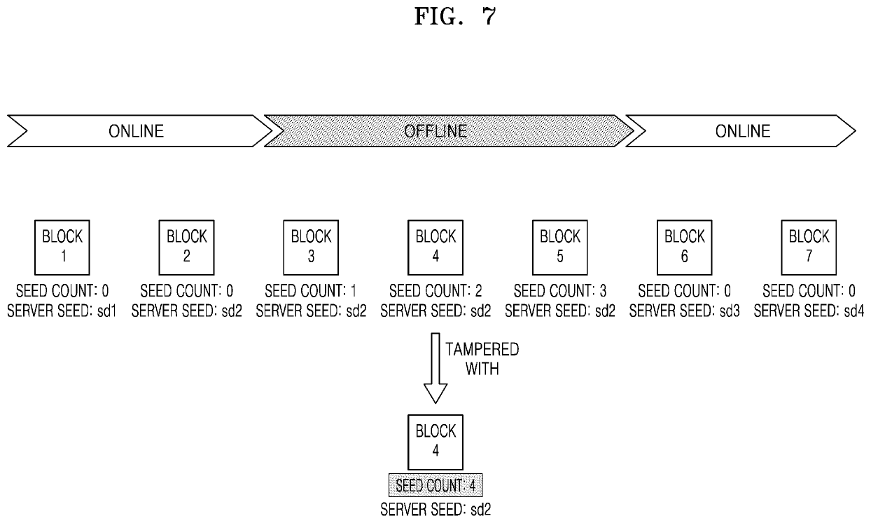

In summary, when tachograph data for which a corresponding block has been generated is modified in an offline state, the tachograph 50 deletes the existing block, generates a block again, and replaces the existing block with the generated block. In this case, the block number of the previously generated block is used without change. However, since a new block is generated while the tachograph 50 is in an offline state, the seed count value used for the generation of a new block is different from the value used for the generation of the existing block. Furthermore, when the server 100 receives block data and a block hash value later, it may determine whether the tachograph data has been tampered with by using them. A detailed description thereof will be given below with reference to FIGS. 7 to 9.

At step 502, the tachograph 50 requests a server seed from the server 100 while transmitting the identification information of the tachograph 50, the identification information of a user, and a block number to the server 100.

In the embodiment shown in FIG. 5, the tachograph 50 is in an offline state and thus the connection with the server 100 is released, so that the server 100 cannot receive a request for a server seed. In FIG. 5, even when the tachograph 50 is in an offline state, it attempts to transmit a request for a server seed, but does not receive a response to the request from the server 100. Alternatively, when the tachograph 50 is in an offline state, it may not attempt to transmit a request for a server seed itself (in other words, it may skip step 502), and may proceed directly to step 503.

At step 503, the tachograph 50 maintains a server seed used for the generation of a previous block, and increases a seed count value by 1.

At step 504, the tachograph 50 generates a server key by applying the server seed, the seed count value, and the block number to a random function.

At step 505, the tachograph 50 calculates the block hash value of a current block by using a server key hash value, a block data hash value, and the block hash value of the previous block. The server key hash value may be obtained by applying the server key generated at step 504 to the hash function, and the block data hash value may be obtained by applying the tachograph data (block data) collected at step 501 to the hash function.

At step 506, the tachograph 50 generates a block by using the block hash value obtained at step 505.

Since the tachograph 50 is still in the state of being released from the server 100, it cannot transmit block data and a block hash value to the server 100. Accordingly, at step 507, the tachograph 50 sets block status to a “not transmitted” state in the header of the generated block.

Thereafter, when the tachograph 50 enters into an online state and the connection with the server 100 is resumed, the tachograph 50 transmits the block data and block hash value of the block to the server 100 at step 508. There may be two or more blocks generated when the tachograph 50 is in an offline state. Accordingly, when the tachograph 50 enters into an online state, it may check the headers of all the blocks for block status, and may transmit the block data and block hash values of blocks whose block status is “incomplete” to the server 100. Once the transmission has been completed, the tachograph 50 changes block status to “transmission completed” in the headers of blocks, for which block data and block hash values have been transmitted, at step 509.

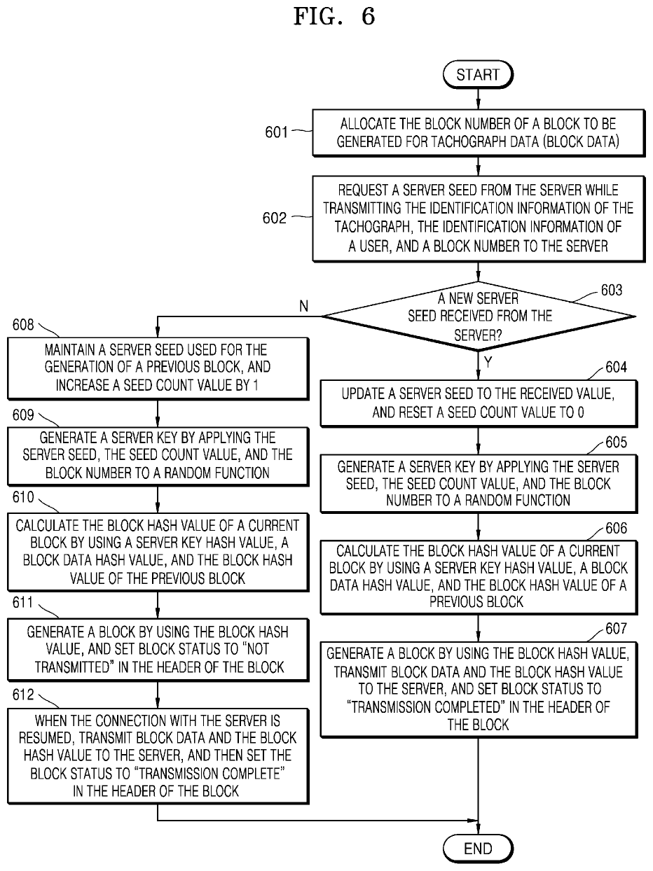

FIG. 6 is a flowchart illustrating a method of managing tachograph data based on a blockchain network according to an embodiment. The method according to the embodiment shown in FIG. 6 includes steps that are processed in a time-series manner by the systems and devices shown in FIGS. 1 and 2. Accordingly, the descriptions that are omitted below but have been given above in conjunction with the systems and devices of FIGS. 1 and 2 may also be applied to the method according to the embodiment shown in FIG. 6.

Referring to FIG. 6, at step 601, the tachograph 50 allocates the block number of a block to be generated for tachograph data (block data).

At step 602, the tachograph 50 requests a server seed from the server 100 while transmitting the identification information of the tachograph 50, the identification information of a user, and a block number to the server 100.

The tachograph 50 determines whether the tachograph 50 has received a new server seed from the server 100 at step 603. If so, the tachograph 50 proceeds to step 604, at which the tachograph 50 updates a server seed to the value (the former server seed) received from the server 100 and resets a seed count value to 0.

At step 605, the tachograph 50 generates a server key by applying the server seed, the seed count value, and the block number to a random function.

At step 606, the tachograph 50 calculates the block hash value of a current block by using a server key hash value, a block data hash value, and the block hash value of a previous block.

At step 607, the tachograph 50 generates a block by using the block hash value, transmits block data and the block hash value to the server 100, and sets block status to “transmission completed” in the header of the block.

Meanwhile, if it is determined at step 603 that the server seed has not been received from the server 100, the tachograph 50 proceeds to step 608, at which the tachograph 50 maintains a server seed used for the generation of a previous block and increases a seed count value by 1. According to another embodiment, when the tachograph 50 is in an offline state, steps 602 and 603 may be omitted, and the process may proceed directly to step 608.

At step 609, the tachograph 50 generates a server key by applying the server seed, the seed count value, and the block number to a random function.

At step 610, the tachograph 50 calculates the block hash value of a current block by using a server key hash value, a block data hash value, and the block hash value of the previous block.

At step 611, the tachograph 50 generates a block by using the block hash value, and sets block status to “not transmitted” in the header of the block.

At step 612, when the connection with the server 100 is resumed, the tachograph 50 transmits block data and the block hash value to the server 100, and then sets the block status to “transmission completed” in the header of the block.

A method by which the server 100 determines whether block data (tachograph data) has been tampered with in the case where a block is generated according to the process described so far will be described in detail below in conjunction with specific examples.

FIGS. 7 to 9 are diagrams illustrating a method of determining whether tachograph data has been tampered with in a method and system for managing tachograph data based on a blockchain network according to an embodiment.

In the embodiments shown in FIGS. 7 to 9, the tachograph 50 generates blocks 1 and 2 in an online state, generates blocks 3 to 5 in an offline state, and generates blocks 6 and 7 in an online state again. Furthermore, it is assumed that tampering (the modification of tachograph data) is performed on some block data in the offline state. In the present embodiments, a block number, a seed count value, and a server seed value follow the rules described above, but are set to arbitrary values for convenience of description.

Referring to FIG. 7, the seed count value of both blocks 1 and 2 generated in the online state is 0, and different values are used for the server seed.

In the case of block 3 generated first in the offline state, the server seed sd2 of the recently generated block (block 2) is used without change, and only the seed count value is increased by 1.

In the embodiment shown in FIG. 7, blocks 3 to 5 are sequentially generated, and then block data included in block 4 is modified. Therefore, block 4 for the modified block data is newly generated and replaces the existing block 4.

As regards the seed count value, each time a new block is generated in the offline state, the seed count value is increased by 1. In particular, the seed count value used for the generation of new block 4 generated after block 5 has been generated becomes 4.

When the tachograph 50 enters into an online state, it transmits the block data and block hash values of blocks 3 to 5, generated in the offline state, to the server 100. In this case, in the case of block 4, block data and a block hash value for the newly generated block are transmitted using the seed count value of 4.

A method by which the server 100 determines whether the block data of block 4 has been tampered with is as follows. As described above, a server seed, a block number, a seed count value, block hash value of a previous block, and block data are required to calculate a block hash value. The server 100 may be aware that the seed count value (hereinafter referred to as the “normal seed count value”) that would have been used when the block data of block 4 was not tampered with is 2, and may also be aware that the server seed becomes sd2 because the server seed is maintained as the latest value in the offline state. Furthermore, the server 100 is not only aware of the block number of each block, but also receives the block hash value of block 3, which is a previous block, from the tachograph data 50 and also receives block data included in block 4.

The server 100 is aware of a random function and a hash function used for the generation of a block in the tachograph 50. Therefore, the server 100 calculates a block hash value for block 4 by using the server seed sd2, block number 4, normal seed count value 2, the block hash value of block 3 and the block data of block 4, and compares the calculated block hash value with the block hash value for block 4 received from the tachograph 50.

The block hash value calculated by the server 100 for block 4 (by using the normal seed count value) does not match the block hash value for block 4 received from the tachograph 50. The reason for this is that the block hash value for block 4 received from the tachograph 50 is calculated using 4, which is a seed count value (hereinafter referred to as the “abnormal seed count value”) updated after the block data has been tampered with, and all other pieces of information excluding the seed count value in the information used for the calculation of the block hash value are the same.

The server 100 determines that the block data of block 4 has been tampered with if the block hash value for block 4 calculated directly by the server 100 does not match the block hash value for block 4 received from the tachograph 50.

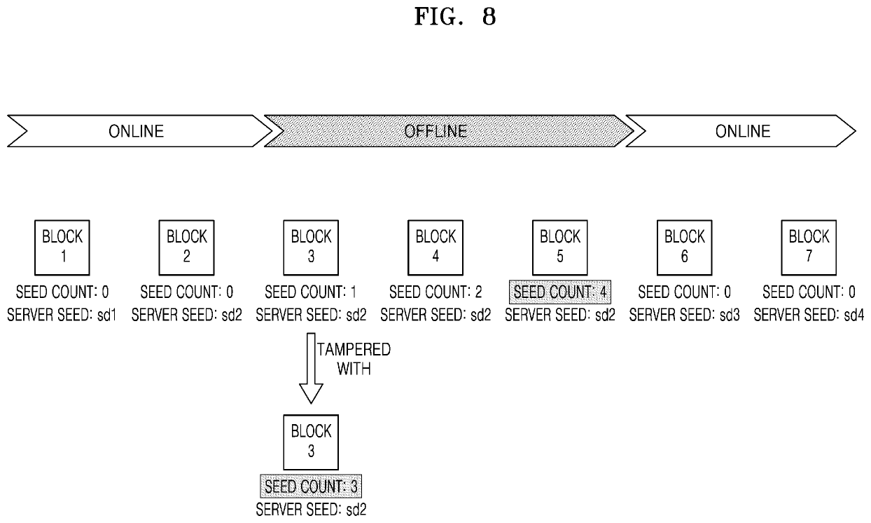

In the embodiment shown in FIG. 8, after blocks 3 and 4 have been sequentially generated, the block data included in block 3 is modified, and then block 5 is generated.

Accordingly, block 3 for the modified block data is newly generated and replaces the existing block 3.

As regards the seed count value, each time each of block 3 and block 4 is generated, the seed count value is increased by 1. Furthermore, when the block data of block 3 is modified and thus block 3 is newly generated, the seed count value is increased by 1 and becomes 3. Thereafter, when block 5 is generated, the seed count value is increased by 1 and becomes 4.

The server 100 receives block data and block hash values for blocks 3 to 5 from the tachograph 50 after entry into an online state, calculates block hash values by using the normal seed count values (1 for block 3, 2 for block 4, and 3 for block 5) for the respective blocks, and then compares the calculated block hash values with the received block hash values. The server 100 may be aware that the directly calculated block hash values for blocks 3 and 5 do not match the received block hash values for blocks 3 and 5. As described above, when the block data of at least one of a plurality of blocks generated in an offline state is modulated, the server 100 may not be able to determine an exact block whose block data has been tampered with, but may determine the fact that the block data of at least one block has been tampered with.

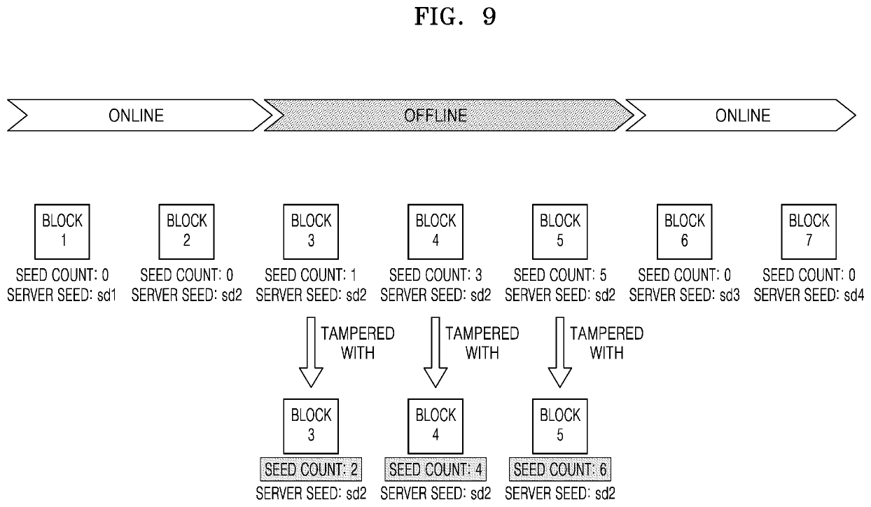

In the embodiment shown in FIG. 9, after block 3 has been generated, the block data of block 3 is modified, and block 3 is generated again. Furthermore, after block 4 has been generated, the block data of block 4 is modified, and block 4 is generated again. Moreover, after block 5 has been generated, the block data of block 5 is modified, and block 5 is generated again. This generation sequence may be found from the seed count value.

The server 100 determines that there are mismatches in block hash values for blocks by calculating block hash values for blocks 3 to 5 by using the normal seed count value and compares them with the block hash values received from the tachograph 50. Accordingly, the server 100 may be aware that the block data of the blocks generated in the offline state has been tampered with.

According to the above-described embodiments, when the tachograph 50 is in an offline state and tachograph data is modified, the server 100 that receives block-related data after the tachograph 50 has entered into an online state may determine that the block data has been tampered with.

Therefore, there may be expected an effect of preventing a driver (a user) of the vehicle 40 from accessing the tachograph 50 in an offline state and freely modifying tachograph data.

The term “unit” used in the above-described embodiments means software or a hardware component such as a field-programmable gate array (FPGA) or application-specific integrated circuit (ASIC), and a “unit” performs a specific role. However, a “unit” is not limited to software or hardware. A “unit” may be configured to be present in an addressable storage medium, and also may be configured to run one or more processors. Accordingly, as an example, a “unit” includes components, such as software components, object-oriented software components, class components and task components, processes, functions, attributes, procedures, subroutines, segments in program code, drivers, firmware, microcode, circuits, data, a database, data structures, tables, arrays, and variables.

Components and a function provided in “unit(s)” may be coupled to a smaller number of components and “unit(s)” or divided into a larger number of components and “unit(s).”

In addition, components and “unit(s)” may be implemented to run one or more central processing units (CPUs) in a device or secure multimedia card.

The method of managing tachograph data based on a blockchain network according to the embodiment descried in conjunction with FIG. 6 may be implemented in the form of a computer-readable medium that stores instructions and data that can be executed by a computer. In this case, the instructions and the data may be stored in the form of program code, and may generate a predetermined program module and perform a predetermined operation when executed by a processor. Furthermore, the computer-readable medium may be any type of available medium that can be accessed by a computer, and may include volatile, non-volatile, separable and non-separable media. Furthermore, the computer-readable medium may be a computer storage medium. The computer storage medium may include all volatile, non-volatile, separable and non-separable media that store information, such as computer-readable instructions, a data structure, a program module, or other data, and that are implemented using any method or technology. For example, the computer storage medium may be a magnetic storage medium such as an HDD, an SSD, or the like, an optical storage medium such as a CD, a DVD, a Blu-ray disk or the like, or memory included in a server that can be accessed over a network.

Furthermore, the method of managing tachograph data based on a blockchain network according to the embodiment descried in conjunction with FIG. 6 may be implemented as a computer program (or a computer program product) including computer-executable instructions. The computer program includes programmable machine instructions that are processed by a processor, and may be implemented as a high-level programming language, an object-oriented programming language, an assembly language, a machine language, or the like. Furthermore, the computer program may be stored in a tangible computer-readable storage medium (for example, memory, a hard disk, a magnetic/optical medium, a solid-state drive (SSD), or the like).

Accordingly, the method of managing tachograph data based on a blockchain network according to the embodiment descried in conjunction with FIG. 6 may be implemented in such a manner that the above-described computer program is executed by a computing apparatus. The computing apparatus may include at least some of a processor, memory, a storage device, a high-speed interface connected to memory and a high-speed expansion port, and a low-speed interface connected to a low-speed bus and a storage device. These individual components are connected using various buses, and may be mounted on a common motherboard or using another appropriate method.

In this case, the processor may process instructions within a computing apparatus. An example of the instructions is instructions which are stored in memory or a storage device in order to display graphic information for providing a Graphic User Interface (GUI) onto an external input/output device, such as a display connected to a high-speed interface. As another embodiment, a plurality of processors and/or a plurality of buses may be appropriately used along with a plurality of pieces of memory. Furthermore, the processor may be implemented as a chipset composed of chips including a plurality of independent analog and/or digital processors.

Furthermore, the memory stores information within the computing device. As an example, the memory may include a volatile memory unit or a set of the volatile memory units. As another example, the memory may include a non-volatile memory unit or a set of the non-volatile memory units. Furthermore, the memory may be another type of computer-readable medium, such as a magnetic or optical disk.

In addition, the storage device may provide a large storage space to the computing device. The storage device may be a computer-readable medium, or may be a configuration including such a computer-readable medium. For example, the storage device may also include devices within a storage area network (SAN) or other elements, and may be a floppy disk device, a hard disk device, an optical disk device, a tape device, flash memory, or a similar semiconductor memory device or array.

According to any one of the above-described solutions, there may be expected an effect in which the server that manages the blockchain network may determine whether the block data (the tachograph data) included in a generated block has been tampered with by using a seed count, which is a variable that changes only when the tachograph is in an offline state, when the tachograph generates a block in the process of storing tachograph data in the blockchain network.

The effects that can be obtained by the embodiments disclosed herein are not limited to the effects described above, and other effects not described above will be clearly understood by those having ordinary skill in the art, to which the present invention pertains, from the foregoing description.

The above-described embodiments are intended for illustrative purposes. It will be understood that those having ordinary knowledge in the art to which the present invention pertains can easily make modifications and variations without changing the technical spirit and essential features of the present invention. Therefore, the above-described embodiments are illustrative and are not limitative in all aspects. For example, each component described as being in a single form may be practiced in a distributed form. In the same manner, components described as being in a distributed form may be practiced in an integrated form.

The scope of protection pursued through the present specification should be defined by the attached claims, rather than the detailed description. All modifications and variations which can be derived from the meanings, scopes and equivalents of the claims should be construed as falling within the scope of the present invention.

What is claimed is:

1. A method of managing tachograph data based on a blockchain network, the method comprising:
allocating, by a tachograph, a block number of a block to be generated for tachograph data collected while a vehicle is driving;
generating a block by using a server seed allocated by a server and a seed count value, which is a variable whose value changes each time the tachograph generates a block in an offline state; and
transmitting a block hash value and block data of the generated block to the server.

2. The method of claim 1, wherein when the tachograph is in an online state, generating the block comprises:
requesting, by the tachograph, the server seed from the server while transmitting identification information of the tachograph, identification information of a user corresponding to the tachograph data, and the block number to the server;
when receiving the server seed from the server, resetting, by the tachograph, the seed count value, and calculating, by the tachograph, a block hash value by using the received server seed and the reset seed count value; and
generating the block by storing the calculated block hash value in a header.

3. The method of claim 2, wherein calculating the block hash value comprises:
generating a server key by applying the received server seed, the reset seed count value, and the block number to a random function;
obtaining a server key hash value and a block data hash value by applying the server key and the tachograph data to a hash function; and
calculating a block hash value of a current block by using the server key hash value, the block data hash value, and a block hash value of a previous block.

4. The method of claim 1, wherein when the tachograph is in an offline state, generating the block comprises:
updating, by the tachograph, the seed count value by increasing the seed count value by 1, and calculating, by the tachograph, a block hash value by using a server seed used for recent block generation and the updated seed count value; and
generating the block by storing the calculated block hash value in a header.

5. The method of claim 4, wherein calculating the block hash value comprises:
generating a server key by applying the server seed used for the recent block generation, the updated seed count value, and the block number to a random function;
obtaining a server key hash value and a block data hash value by applying the server key and the tachograph data to a hash function; and
calculating a block hash value of a current block by using the server key hash value, the block data hash value, and a block hash value of a previous block.

6. The method of claim 1, wherein allocating the block number comprises:
when at least part of tachograph data for which a corresponding block has already been generated is modified, deleting the generated block; and
allocating a block number identical to a block number of the deleted block to a block to be generated for the modified tachograph data.

7. A non-transitory computer-readable storage medium having stored thereon a program that, when executed by a processor, causes the processor to execute the method of claim 1.

8. A computer program that is executed by a computing apparatus and stored in a non-transitory computer-readable storage medium in order to perform the method of claim 1.

9. A tachograph for managing tachograph data based on a blockchain network, the tachograph comprising:
a communication interface configured to communicate with a server;
storage configured to store a program for managing tachograph data based on a blockchain network; and
a controller including at least one processor, and configured to store the tachograph data in the blockchain network by executing the program;
wherein the controller allocates a block number of a block to be generated for tachograph data collected while a vehicle is driving, generates a block by using a server seed allocated by the server and a seed count value, which is a variable whose value changes each time the tachograph generates a block in an offline state, and transmits a block hash value and block data of the generated block to the server.

10. The tachograph of claim 9, wherein when the tachograph is in an online state, the controller, in the generation of the block:
requests the server seed from the server while transmitting identification information of the tachograph, identification information of a user corresponding to the tachograph data, and the block number to the server;
when receiving the server seed from the server, resets the seed count value, and calculates a block hash value by using the received server seed and the reset seed count value; and
generates the block by storing the calculated block hash value in a header.

11. The tachograph of claim 10, wherein the controller, in the calculation of the block hash value:
generates a server key by applying the received server seed, the reset seed count value, and the block number to a random function;
obtains a server key hash value and a block data hash value by applying the server key and the tachograph data to a hash function; and
calculates a block hash value of a current block by using the server key hash value, the block data hash value, and a block hash value of a previous block.

12. The tachograph of claim 9, wherein when the tachograph is in an offline state, the controller, in the generation of the block:
updates the seed count value by increasing the seed count value by 1;
calculates a block hash value by using a server seed used for recent block generation and the updated seed count value; and
generates the block by storing the calculated block hash value in a header.

13. The tachograph of claim 12, wherein the controller, in the calculation of the block hash value:
generates a server key by applying the server seed used for recent block generation, the updated seed count value, and the block number to a random function;
obtains a server key hash value and a block data hash value by applying the server key and the tachograph data to a hash function; and
calculates a block hash value of a current block by using the server key hash value, the block data hash value, and a block hash value of a previous block.

14. The tachograph of claim 9, wherein the controller, in the allocation of the block number:
when at least part of tachograph data for which a corresponding block has already been generated is modified, deletes the generated block; and
allocates a block number identical to a block number of the deleted block to a block to be generated for the modified tachograph data.
